(19) United States
(12) Patent Application Publication
(10) Pub. No.: US 2009/0271279 A1
(43) Pub. Date: Oct. 29, 2009

(54) Motion star casting and auditioning system

(76) Inventor: Rick Albert Brandelli, San Pedro, CA (US)

Correspondence Address: Lauson & Tarver LLP, 880 Apollo Street, SUITE 301, El Segundo, CA, 90245, US

(21) Appl. No.: 12/072,673

(22) Filed: Apr. 25, 2008

(51) Int. Cl. G06Q 30/00

(52) U.S. Cl. 705/26

(57) ABSTRACT

A Motion Star Casting (MSC) and auditioning system for directly connecting the casting directors and artist is disclosed. MSC is an innovative and user-friendly website for casting directors, production companies, agents and other industry professionals to upload a document or video illustrating their casting need. The artists can read their lines or mimic a dance routine and then upload their video clips to their Video Action Portfolios (VAP). The artists can also search for opportunities, view video of the performances, and upload their own rendition for consideration to the selection committee. After uploading the VAP, the artists can send Video Action Responses (VAR) to the casting directors. The Casting directors can save VAP and VAR in their account for continued promotion of the artists.

### CROSS-REFERENCE TO RELATED APPLICATION

None

### FEDERALLY SPONSORED RESEARCH

None

### SEQUENCE LISTING OR PROGRAM

None

### BACKGROUND

The invention relates to casting system, and more particularly to motion star casting and auditioning system for entertainment industry.

In an entertainment industry, traditionally casting directors or producers (buyers) send announcements about an audition to the public. These announcements are called casting calls. Agents or talents (sellers) answer the casting calls by submitting the talent information. Then, the casting executives gather the talents names for audition sessions from lists or other internal sources before or after casting calls have been sent. After gathering the submissions, buyers can go through the submissions and sort them into different lists. The buyers then start to organize the audition times for the sellers.

The process of organizing the schedule for auditions is time-consuming and arduous. It involves making lists of different audition times for each actor, making phone calls and sending emails to the talents. In addition to creating audition times, the buyers provide information about the audition location, the project, the script or script pages. The actors perform the audition in the location said by the buyers.

In a traditional method and system for scheduling auditions, the buyer posts a breakdown for distribution to sellers. Sellers then respond to the buyer by sending talent submissions online. The buyer shortlists the talent by sorting through the submissions, placing the actors submitted into three groups, A, B, or C, or omitting them from any group, and schedules talent for upcoming auditions. The buyer then contacts sellers for talent availability (scheduling). The seller contacts talent for their availability (scheduling). The seller contacts buyer with confirmations and regrets (scheduling). Then the buyer posts sides and scripts for upcoming auditions (scheduling). The seller distributes sides and scripts to auditioning talent (distribution). The buyer then shoots the audition session and uploads the video to the buyer's (studio's) cast list for the project. The buyer then distributes the audition sessions.

In another traditional casting systems and methods, talent information data related to broadcast productions are collected, stored and updated. A computer network will be provided in connection with software, the latter containing all required forms and paperwork necessary to have union talent, and in particular, performers who are members of either the Screen Actors Guild, the American Federation of Television and Radio Actors or the American Federation of Musicians. The software is operative to create a digital job jacket for all forms, contracts and talent details generated in relation to a specific broadcast production. Talent information data is continuously updated during the production process and can be selectively accessed over the computer network by those entities having a need to access such information, such as production companies, casting agencies, paymasters and performers. The systems and methods are operative to substantially eliminate inefficient and error prone practices utilized, as well as serve as a profitable business model.

A music casting system, attempts to revolutionize the music industry through a site that uploads music and provides artist an internet based venue to sell their music. Record companies would be able to scan potential artist, bypassing the existing music submission process.

The prior art casting and audition systems are failed to fulfill the customer's needs and are antiquated, inadequate and nonfunctional system of finding the talents critical for an industry to function. Also, the current systems are time consuming, costlier and difficult in scheduling. Further, the current system does not allow the entire film/entrainment industries to interact with the millions of artist worldwide.

Therefore, it is an object of the present invention to overcome the shortcomings of in the prior art and to provide tools that allow both the casting directors and artists a superior alternative to the current antiquated auditioning process. It is a further object of the present invention to provide an innovative and user-friendly platform for casting directors, production companies, agents and other industry professionals to upload a document or video illustrating their casting need. It is a still further object of the present invention to the users a location where they can search for opportunities, view video of the performances, and upload their own rendition for consideration to the selection committee. These and other objects are set forth in the following detailed description and claims.

### SUMMARY

The present invention is an innovative new website that connects the multitude of entertainment, motion picture, theatre, television and performance castings directly to actors and performers worldwide. The interactive website avoids distance, cost and scheduling barriers that limit the casting side of the entertainment industry.

Motion star casting (MSC) is a website that supports the entertainment community by providing users a location where they can search for opportunities, view video of the performances, and upload their own rendition for consideration to the selection committee. The artists can read their lines or mimic a dance routine and then upload their video clips to their portfolios. The industry professionals or casting director are no longer limited to local talents and are provided with more variety and convenience; allowing them to view Video Castings Responses (VCR) from talent world wide. The actors' VCRs can be viewed by potential employers as well as stored on their Video Action Portfolio (VAP) for continued promotion of their talents. Video Acting Portfolios contain multiple clips of the artist work, resume, head clips and photos.

Motion Star Casting is the bridge that allows the exchange of information related to casting and auditioning. As a member of this website, artists can globally access the website for employment and can promote their talents. Motion Star Casting is a free site, equivalent to the likes of MySpace and YouTube. MSC offers different levels of service, some that require a fee and will quickly become the dominant advertisement destination for vendors of products and services that target the entertainment industry worldwide. MSC site will save the industry millions of dollars and thousands of hours as live auditions and casting calls become a thing of the past.

Although particular embodiments of the present invention have been described in the foregoing description, it is to be understood that the present invention is not to be limited to just the embodiments disclosed, but that they are capable of numerous rearrangements, modifications and substitutions without departing from the description herein.

### BRIEF DESCRIPTION OF THE DRAWINGS

FIG. 1 is a block diagram of major components of a preferred embodiment of the present invention.

FIG. 2 is a web flow chart illustrating the casting and auditioning process of the present invention.

FIG. 3 is a window or a webpage of the present invention, illustrating the opening page of MSC.

FIG. 4 is a window or a webpage of the present invention, illustrating the Frequently Asked Questions (FAQ's) or the benefits of MSC.

FIG. 5 is a window or a webpage of the present invention, illustrating the site tour details showing the major contents of the MSC.

FIG. 6 is a window or a webpage of the present invention, illustrating the details required for registering as a star.

FIG. 7 is a window or a webpage of the present invention, illustrating the details required for registering as a corporate.

FIG. 8 is a window or a webpage of the present invention, illustrating the details required for logging into the MSC accounts either as star or corporate.

FIG. 9 is a window or a webpage of the present invention, illustrating the star account.

FIG. 10 is a window or webpage of the present invention illustrating the corporate account.

### REFERENCE NUMERALS

10 . . . Motion star casting and auditioning system

11 . . . Casting directors or buyers

12 . . . Artists or sellers

13 . . . Network

14 . . . web server

15 . . . Database of potential members

16 . . . Database of advertisers

17 . . . Database of industry affiliates

### DETAILED DESCRIPTION

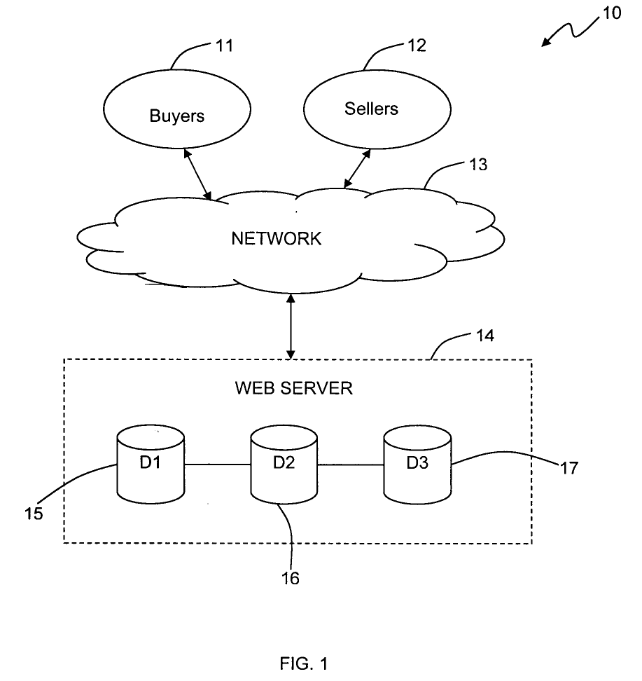

Referring to FIG. 1, a preferred embodiment of the major components of a Motion Star Casting (MSC) system is illustrated and indicated generally by a reference numeral 10. The system 10 directly connects the buyers 11 and sellers 12 involved in entire entrainment industry. The buyers 11 and sellers 12 are connected to a digital computer network 13 carrying and routing digital data between the system 10 and buyers 11 and sellers 12 over a communication link. The web server 14 comprises of databases 15, 16, 17 for storing information related to potential members, advertisers and industry affiliates respectively.

The system 10 allows the buyers 11 to upload the casting calls and allow the sellers 12 to respond to the casting calls. The system 10 also allows the sellers 12 to search for opportunities, view video of performance and upload their own rendition.

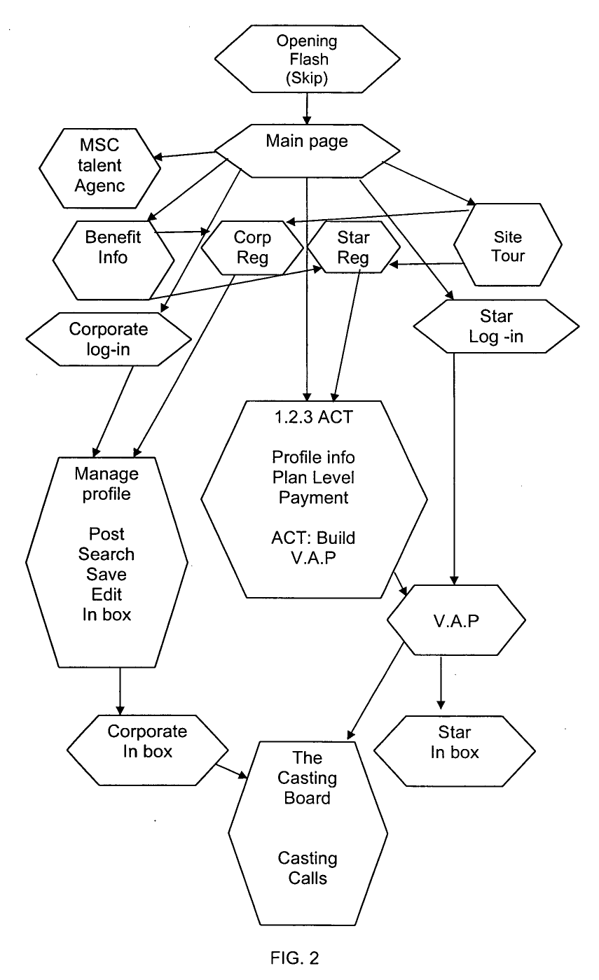

Referring to FIG. 2, illustrates a web flow chart of casting and auditioning process. The buyers and sellers are allowed to register in a corporate account and star accounts respectively. Then the buyer and sellers are allowed to login in their accounts. After login, the buyers upload at least one casting call comprising a document or video illustrating their casting needs. The sellers search casting calls that suits their talent. Then the sellers upload video clips prepared for casting calls in a Video Action Profile (VCP). After uploading the data, the seller sends a Video Casting Responses (VCR) to the buyers.

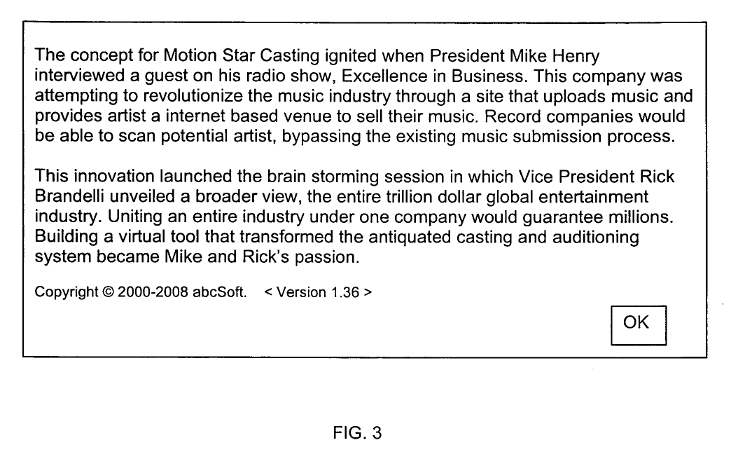

Referring to FIG. 3, illustrates an opening window or first web page illustrating the information such as the emotional excitement, legitimacy and founders of the invention. The Oscar experience of invention can also be displayed in the opening page so that the user can read the provided information and aware of the product. The user of the website can skip the opening page and can proceed to the main page.

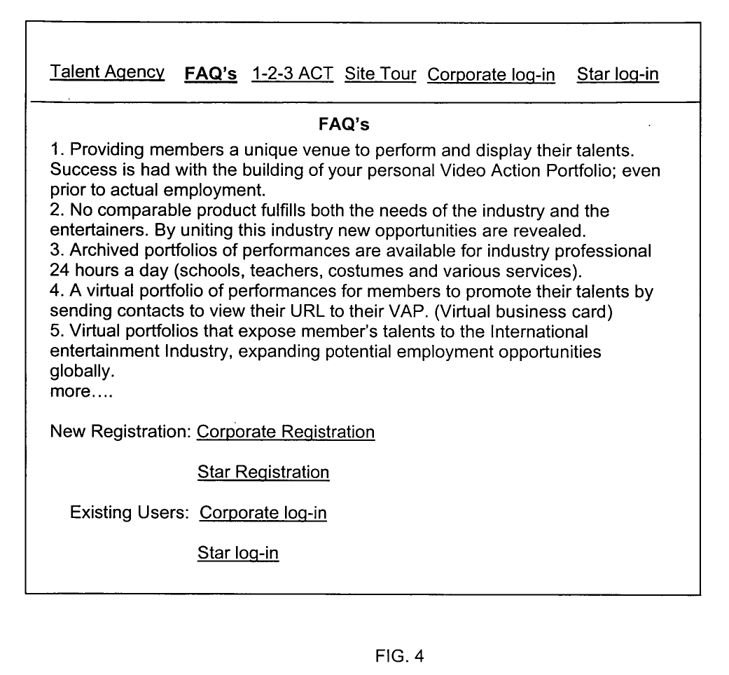

FIG. 4 is a window or a webpage of the present invention illustrating the Frequently Asked Questions (FAQ's) or the benefits of MSC. The users are provided with various benefits of MSC and the various benefits of using MSC are as follows. MSC provides members a unique venue to perform and display their talents. The talents can build their personal Video Action Portfolio even prior to actual employment. No comparable product fulfills both the needs of the industry and the entertainers. By uniting this industry new opportunities are revealed. Archived portfolios of performances are available for industry professional 24 hours a day (schools, teachers, costumes and various services). A virtual portfolio of performances for members promotes the talents by sending contacts to view their URL to their VAP (Virtual Business Card). Virtual portfolios expose the talents of the members to the International entertainment Industry, expanding potential employment opportunities globally. Foreign actors and talents are viewed and screened by a variety of entertainment industry professionals.

Further, by reducing the travel requirements to major entertainment capitals, auditions are completed online; traveling will be to only finalize employment. MSC expands and greatly improves the entertainment industries talent pool through virtual displays. Improvement and/or creation of foreign countries current auditioning systems are also possible. Also, MSC is an excellent advertisement space for vendors of filming locations and stage props. Virtual casting reduces the fear factor and supports the entertainers in to provide their best performances. Practice tool are used to review the performances during auditions through various media players. MSC provides an advanced global advertisement medium, uniting the various segments of entertainment vendors of products and services.

After going through the benefits information and FAQ's, the user can register to login in order to avail the benefits. The benefits screen also allows the registered users to login into their accounts.

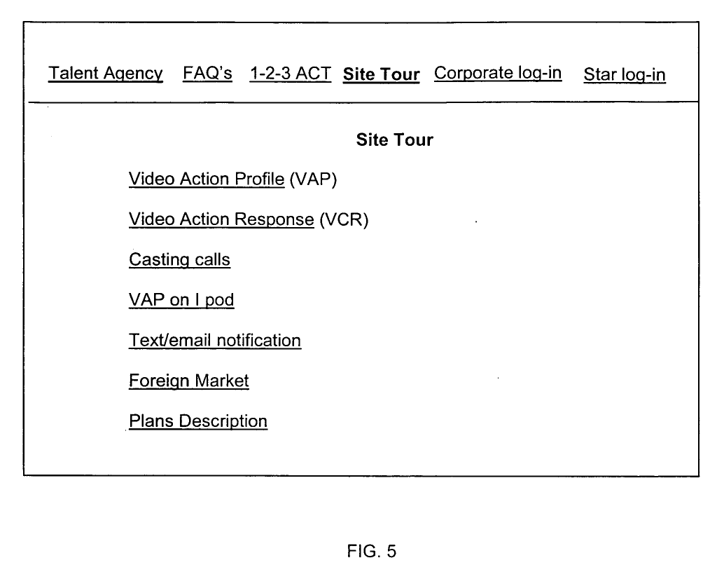

FIG. 5 is a window or a webpage of the present invention, illustrating the site tour details showing the major contents of the MSC. Site tour provides quick links to the major pages or information that are often visited or requested by the user. The quick links include VAP, VCR, casting calls, VAP on I pod, Text or email notification, foreign market and plans description.

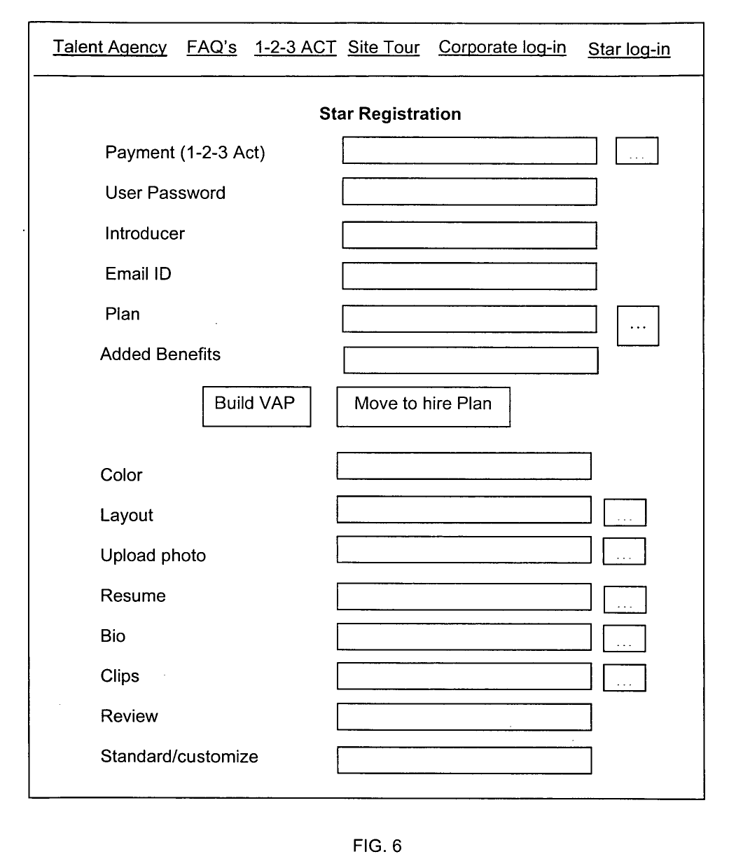

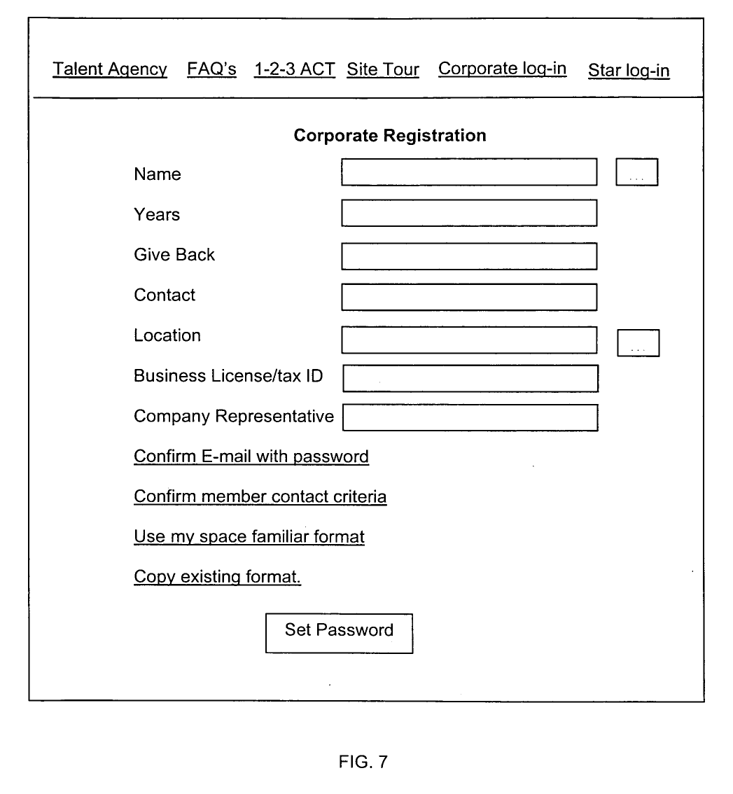

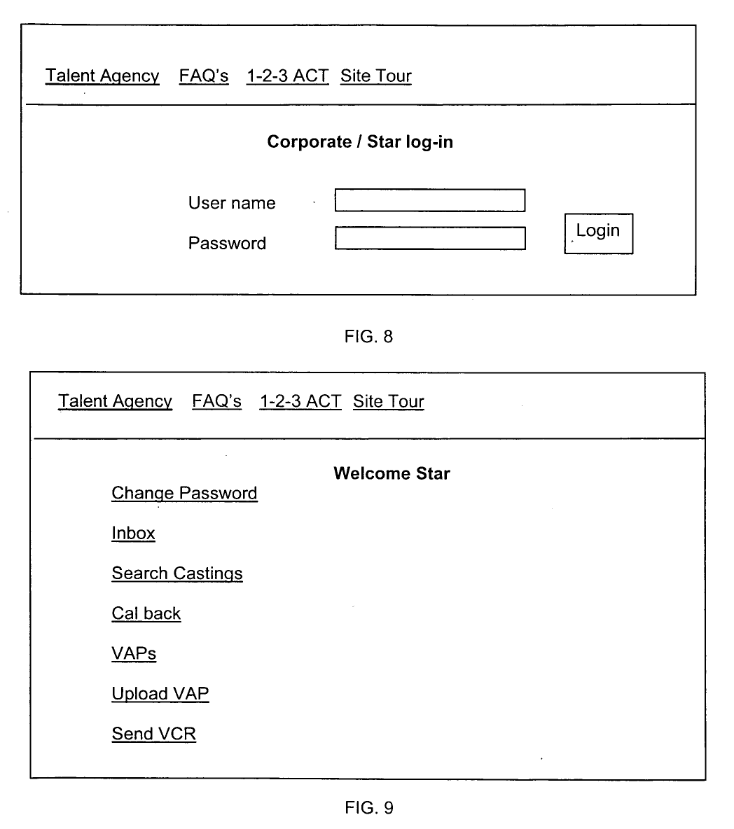

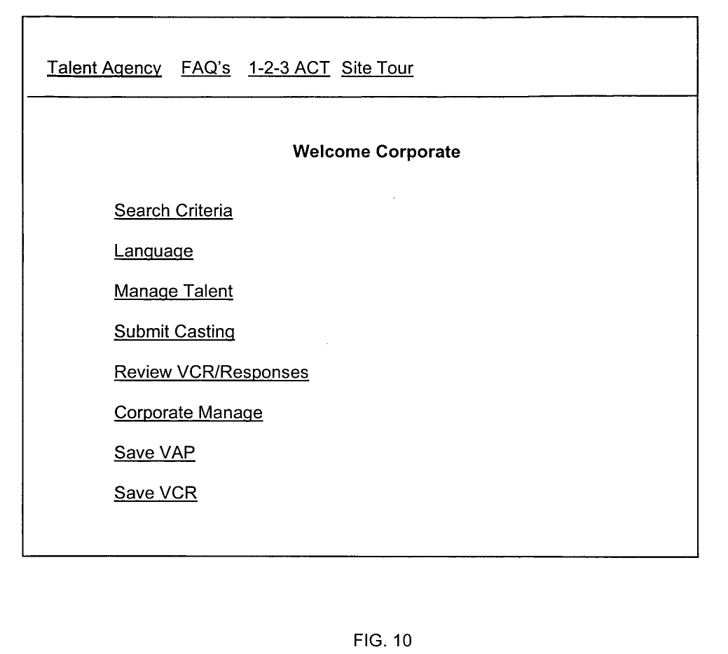

Referring to FIG. 6, the window or a webpage allows the user to register as star. The window or webpage provides various details required for star registration. User can select the payment and membership plans that suit their requirement. The window or the webpage also allows the user to built VAP and customize their profile. In corporate registration as referred in FIG. 7, the user provides the company information and register as a corporate. After registering in corporate registration the user can login into their corporate account and submit the casting calls to the sellers. FIG. 8 shows the star or corporate login screen. Referring to FIG. 9 and FIG. 10, illustrates the star and corporate accounts used in one embodiment of the invention respectively.

Motion Star Casting places the entire entertainment industry under one umbrella. Joining the leagues of Facebook, YouTube and eBay, entertainers across the World will accomplish their dreams through MSC. MSC allows auditioning for gigs around the world, receiving, reviewing and auditioning from the comfort of their homes. A single artist can send their performance to auditions thousands of miles away, responding directly to casting calls with video auditions. The casting industry, producers and promoters can search through the constantly expanding pool of talent for that perfect artist to fit their events 24/7; saving time and money. Casting directors can send out video audition clips and review archives of talent performances. Virtual auditions will quickly become the norm. Motion Star Casting will control the market and replace all other forms of casting.

Clearly defined attracting, gathering, driving, capturing, and holding mechanisms are implemented into the MSC business model. Due to the rapid innovations of web based technology, holding customers through more than product satisfaction is a must. MSC shifts customers from the current accepted casting methods, to the innovation that reveal the lacks of the existing systems; destroying the past systems marketing campaigns and branding efforts. MSC are significant, but require only slight shifts in customer habits.

In one embodiment of the invention, the MSC provides different levels of memberships to the user. The free 1st level of membership combined with the multiple categories of members served, (model, actor, dancer, etc. . . . ) is designed to remove all barriers of membership. Customers are captured through profile building, networking, and opportunity of employment. Creating VAPs and VCRs require time at our site; daily viewing for casting responses only further captures the customer. The 2nd level of membership includes receiving a video camera and immediate membership in the Inheritance Foundation (IF). IF provides constant support and social events that are designed to make Motion Star Casting the site to be. Incentives for existing members to recruit new members are also built into the model; free membership with recruitment.

Editing and updating the personal VAP and searching the globe for auditions are powerful holding mechanisms that will keep our users at MSC site for an extended period of time. The community aspect of MSC is further supported through free online dating and networking features.

The website requires updating of the member's VAP, Checking for callbacks, casting calls and creating new VCRs. Communication between members through forums, inbox and chats. The high amount of traffic that this mechanism generates adds to the database, which is the driving mechanism incentive to capture advertisers and other vendors.

All features disclosed in this specification, including any accompanying claims, abstract, and drawings, may be replaced by alternative features serving the same, equivalent or similar purpose, unless expressly stated otherwise. Thus, unless expressly stated otherwise, each feature disclosed is one example only of a generic series of equivalent or similar features.

Although preferred embodiments of the present invention have been shown and described, various modifications and substitutions may be made thereto without departing from the spirit and scope of the invention. Accordingly, it is to be understood that the present invention has been described by way of illustration and not limitation.

What is claimed is:

1. A motion star casting and auditioning system for directly connecting a plurality of buyers with a plurality of sellers involved in a plurality of entrainment industries, wherein said plurality buyers and said plurality of sellers are connected to a digital computer network carrying and routing digital data between said system and said plurality of buyers and sellers over a communication link, comprising:
a plurality of databases for storing information related to potential members, advertisers and industry affiliates;
a server operatively coupled to said plurality of databases, said server being accessible by said computer network and operative to allow the said plurality of buyers to send a plurality of casting calls and allow the said plurality of sellers to respond to the said plurality of casting calls; and
wherein said server is further operative to allow the plurality of sellers to search for opportunities, view video of performance and upload their own rendition.

2. The system of claim 1, wherein said plurality of sellers prepare at least one document or video according to at least one of the said plurality of casting call and upload the said document or video in their Video Action Portfolios (VAP).

3. The system of claim 1, wherein the said plurality of sellers prepare at least one interested document or video and upload the said document or video in the said Video Action Portfolios (VAP).

4. The system of claim 1, wherein said plurality of buyers save at least one Video Action Portfolios (VAP) and save at least one Video Casting Reponses (VCR) of at least one of the said plurality of seller for continued promotion of at least one of said plurality of sellers.

5. The system of claim 1, wherein said Video Action Portfolios (VAP) contains multiple clips of artist work, resume, head clips and photos.

6. The system of claim 1, wherein said plurality of sellers involved in said plurality of entrainment industries comprise a plurality of casting directors, a plurality of production companies, agents and other industrial professionals.

7. The system of claim 1, wherein the said plurality of sellers and said plurality of buyers are directly connected using a website.

8. A motion star casting and auditioning method for directly connecting a plurality of buyers with a plurality of sellers involved in a plurality of entrainment industries, comprising:
allowing a plurality of buyers to register in a corporate account;
allowing a plurality of sellers to register in a star account;
allowing the registered said plurality of buyers to login in the said corporate account;
allowing said plurality of sellers to login in the said star account;
uploading at least one casting call comprising a document or video illustrating the casting need of said plurality of buyers;
allowing said plurality of sellers to search said casting call that suits their talent;
allowing said plurality of sellers to upload a plurality of video clips prepared for said casting calls in a Video Action Profile (VCP); and allowing said plurality of sellers to send a Video Casting Responses (VCR) to said plurality of buyers.

9. The method of claim 8, further comprising:
allowing said plurality of sellers to save said VCR in said corporate account; and
allowing said plurality of sellers to save said VCP in said corporate account.

10. The method of claim 8, wherein the said plurality of sellers and said plurality of buyers are directly connected using a website.

11. The method of claim 8, wherein the said plurality of sellers send contacts to said plurality of buyers for viewing URL and VAP of the said plurality of sellers.
